(19) United States
(12) Patent Application Publication
(10) Pub. No.: US 2002/0000772 A1
(43) Pub. Date: Jan. 3, 2002

(54) Image display apparatus

(75) Inventor: Takenobu Kitahara, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/883,324

(22) Filed: Jun. 19, 2001

(30) Foreign Application Priority Data
Jun. 22, 2000 (JP) 2000-188163

(51) Int. Cl. H01J 1/62; G02F 1/133

(52) U.S. Cl. 313/503; 349/33; 359/237

(57) ABSTRACT

On a glass substrate, a prism sheet for condensing rays emitted from an emitting layer, a circularly polarizing filter, and an antireflection film are laminated. The prism sheet is provided for each of red, green and blue display elements of the emitting layer and is divided by separators so as not to interfere one another. Control electrodes are laminated on and under the emitting layer. A positive pole is formed from ITO film and a hole carrying layer; and a negative pole is formed from a metal electrode and an electron carrying electrode.

### BACKGROUND OF THE INVENTION

1. Field of the Invention

The present invention relates to an image display apparatus and more particularly to the image display apparatus in which a prism film is provided between an image emitting surface and an image display surface.

The present application claims priority of Japanese Patent Application No. 2000-188163 filed on Jun. 22,2001, which is hereby incorporated by reference.

2. Description of the Related Art

Conventionally, a prism sheet that is a transparent sheet having a prism surface on which V-shaped irregularities are continuously formed is put on a light-introducing plate of a backlight for liquid crystal and condenses light from the light-introducing plate in a vertical upward direction, using a characteristic which condenses dispersed-light entering from a back face into the prism sheet in an approximately vertical direction.

FIG. 5 is a view showing a principle in which radiant light rays from a conventional transmissive liquid crystal backlight are condensed using the prism sheet. A light ray 302 from a light source 314 is reflected by a reflecting plate 315 in one direction and an optical path is changed in an upward direction while passing through a light-introducing plate 316. Then, the light ray 102 is condensed in a vertical upward direction by a prism sheet 303 provided on the light-introducing plate 316 and is projected to an upward liquid crystal incident surface (not shown).

Also, radiant light from a display element such as organic EL (ElectroLuminescence) device or a like is conventionally condensed by a condensing lens, and condensing of the radiant light has been tried by the prism sheet.

However, there is a problem in that, when the prism sheet used in the light-introducing plate is put on the upward surface of the display element such as organic EL and is used, light rays which have changed optical paths from respective display elements of the organic EL interfere one another and an image can not be displayed.

### SUMMARY OF THE INVENTION

In view of the above, it is an object of the present invention to provide an image display apparatus capable of advancing luminance viewed from a front face of a display face without disarrangement of display of an image, not limited to a self-emitting image display apparatus.

According to an aspect of the present invention, there is provided an image display apparatus including:

one or more prism sheets provided between an image emitting surface of an image generating part in the image display apparatus and an image display surface of the image display apparatus, divided so as to be respectively corresponded to display elements that are a minimum of display units forming an image and provided with a prism surface on an exit surface so that rays incident on an incident surface exit in an approximately vertical direction of the incident surface.

In the foregoing, a preferable mode is one wherein the image display apparatus is an organic electroluminescence display and includes a metal electrode layer, an electron carrying layer formed on an upper surface of the metal electrode layer, an emitting layer formed on an upper surface of the electron carrying layer, a hole carrying layer formed on an upper surface of the emitting layer, an ITO (Indium Tin Oxide) film formed on an upper surface of the hole carrying layer, a glass substrate arranged on an upper surface of the ITO film and an circularly polarizing filter and an antireflection film arranged on an upper surface of the glass substrate, and wherein the prism sheet is provided between the ITO film and the antireflection film, is divided so as to be respectively corresponded to display elements that are minimum display units forming an image of the emitting layer and is provided with a prism surface on an exit surface so that light rays incident on an incident surface exit in an approximately vertical direction of the incident surface.

Also, a preferable mode is one wherein the prism sheet is provided between the glass substrate and the circularly polarizing filter.

Also, a preferable mode is one wherein the image display apparatus is a liquid crystal display and includes a lower substrate part including a first glass substrate, a first polarizing filter formed under a lower surface of the first glass substrate and a first ITO film formed on an upper surface of the glass substrate and provided with display elements that are minimum display units forming an image in a matrix, a light-introducing plate arranged under a lower surface of the lower substrate part, a light source arranged adjacently to the light-introducing plate, an upper substrate part including a second glass substrate, a color filter divided so as to be respectively corresponded to the display elements that are the minimum display units forming the image and formed on the second glass substrate and a second ITO film that is a common electrode formed under a lower side of the second glass substrate, liquid crystal elements arranged between the lower substrate part and the upper substrate part, a second polarizing filter provided on an upper surface of the upper substrate part and antireflection film provided on the second polarizing filter, and wherein the prism sheet is provided between the upper substrate part and the antireflection film, is divided so as to be respectively corresponded to the display elements that are minimum display units forming an image and is provided with a prism surface on an exit surface so that light rays incident on an incident surface exit in an approximately vertical direction of the incident surface.

Also, a preferable mode is one wherein the prism sheet is provided between the second polarizing filter and the antireflection film.

Also, a preferable mode is one wherein the prism sheet is provided between the upper substrate sheet and the second polarizing filter.

With this configuration, display luminance can be improved without increasing luminance of a light source or power consumption. As its reason, the prism sheet refracts optical paths so as to be in the vertical direction of the display surface, whereby luminance in a vertical direction of a display surface is increased without increasing luminance of the light source.

Also, an angle of visibility becomes narrow and therefore privacy can be kept. Particularly, as to a portable apparatus or a like, it is possible to protect a furtive glance since the portable apparatus is often used in public. As its reason, the prism sheet refracts optical paths so as to be in the vertical direction of the display surface.

Still Further, a manufacturing process is simple. As its reason, a structure is simple, since only a prism sheet divided for each minimum display unit (dot) is laminated.

### BRIEF DESCRIPTION OF THE DRAWINGS

The above and other objects, advantages, and features of the present invention will be more apparent from the following description taken in conjunction with the accompanying drawings in which:

FIG. 1 is a schematic view showing that radiant light rays are condensed by a prism sheet within a display element in an image display apparatus having one prism sheet according to a first embodiment of the present invention;

FIG. 2 is a schematic sectional view showing an image display apparatus of an organic EL display type provided with the prism sheet according to a first embodiment of the present invention;

FIG. 3 is a schematic sectional view showing a refraction state of light rays in the prism sheet of the image display apparatus shown in FIG. 2;

FIG. 4 is a schematic sectional view showing a liquid crystal image display apparatus provided with a prism sheet according to a second embodiment of the present invention; and

FIG. 5 is a schematic view showing a principal in which a radiant light ray from a conventional transmissive liquid crystal backlight is condensed.

### DETAILED DESCRIPTION OF THE PREFERRED EMBODIMENTS

Best modes of carrying out the present invention will be described in further detail using various embodiments with reference to the accompanying drawings.

### First Embodiment

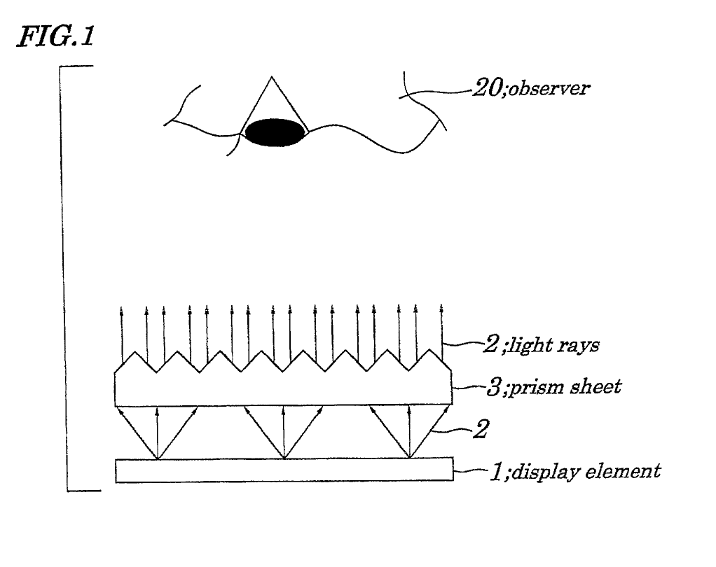

FIG. 1 is a schematic view showing that radiant light rays are condensed by a prism sheet in one image display apparatus having the prism sheet according to a first embodiment of the present invention and showing one display element.

In this figure, light rays 2 irradiating from a display element 1 in all directions pass through a prism sheet 3 provided for each display element 1, and thereby the prism sheet 3 condenses the light rays 2 in a front direction of the display element 1 when the display element 1 is viewed from a display surface and the prism sheet 3 advances luminance. Therefore, it is possible to substantially advance luminance for an observer 20 in a front direction without increasing luminance of a light source, namely, it is possible to advance luminance without increasing power consumption.

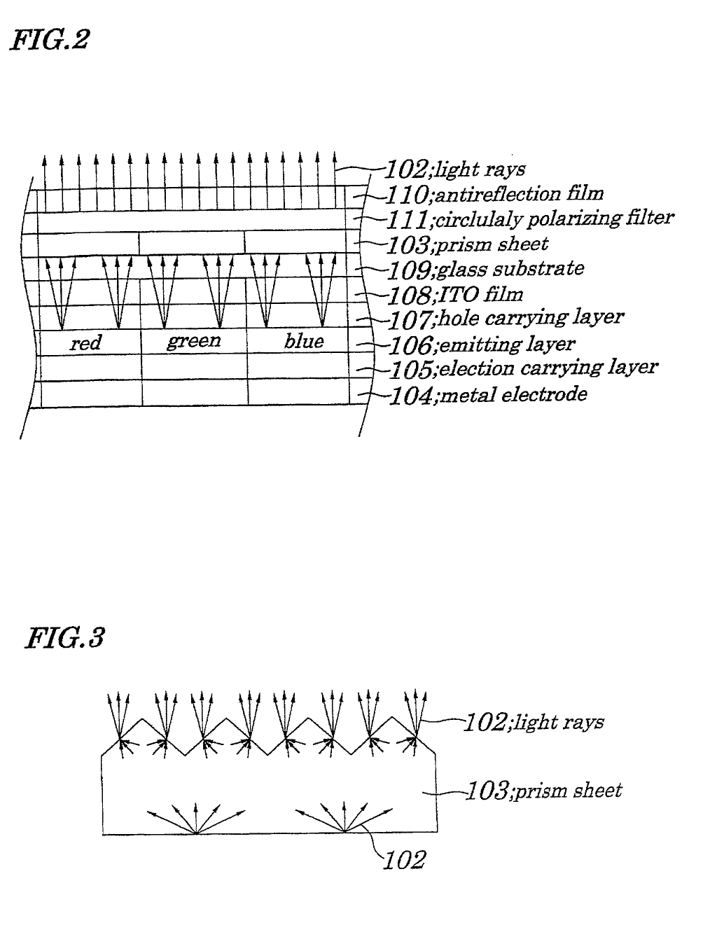

FIG. 2 is a schematic sectional view showing an image display apparatus of an organic EL display type provided with the prism sheet according to the first embodiment of the present invention. In FIG. 2, a prism sheet 103 for condensing light rays 102 emitted from an emitting layer 106 is put on a glass substrate 109 and a circularly polarizing filter 111, and an antireflection film 110 for protecting reflection of outer light rays are put on the prism sheet 103. The prism sheet 103 is divided for a red display element, a blue display element, and a green display element of the emitting layer 106 and is respectively divided by separators so as not to interfere one another. On an upper side and a lower side of the emitting layer 106, control electrodes (not shown) for emitting the emitting layer 106 and for controlling luminance are laminated so that the emitting layer 106 is put between the control electrodes. As to the control electrodes, a positive pole is provided in the upper side of the emitting layer 106 and a negative pole is provided in the lower side of the emitting layer 106. Since it is necessary for the positive pole to penetrate the light rays 102 emitted from the emitting layer 106, an electrode is formed by an ITO film 108 and a hole carrying layer 107 which are transparent electrodes. The negative pole is formed by a metal electrode 104 and an electron carrying layer 105 that are formed from metal.

FIG. 3 is a schematic sectional view showing a refraction state of light rays in the prism sheet 103 of the image display apparatus shown in FIG. 2. In FIG. 3, as to scattered light rays 102 incident on the prism sheet 103 from its lower side via the glass substrate 109 (FIG. 2), optical paths are refracted by optical refraction function of a prism surface of the prism sheet 103, and scattered light rays 102 are condensed in a vertical upward direction of the display surface.

Next, explanations will be given of display operations of the image display apparatus having the prism sheet 103 according to the first embodiment of the present invention with reference to FIG. 2.

When positive electric potential is applied to the ITO film 108 of the positive pole and negative electric potential is applied to the metal electrode 104 of the negative pole, holes are injected from the ITO film 108 of the positive pole to the emitting layer 106 via the hole carrying layer 107 and electrons are injected from the metal electrode 104 of the negative pole to the emitting layer 106 via the electron carrying layer 105, singlet excitation is made by recombining holes and electrons in the emitting layer 106, and then energy of the singlet excitation is changed into the light rays 102. The light rays 102 emitted from the emitting layer 106 pass through the hole carrying layer 107, the ITO film 108 and the glass substrate 109, and then are condensed in the vertical upward direction of the display surface by the prism sheet 103 in a case of the first embodiment.

In the first embodiment, the prism sheet 103 is put on the glass substrate 109, however, the prism sheet 103 may be laminated in any number of layers only if the prism sheet 103 is put between the emitting layer 106 and the display surface, and a plurality of prism sheets 103 may be laminated.

### Second Embodiment

Further, an image display apparatus having a prism sheet according to a second embodiment of the present invention will be described.

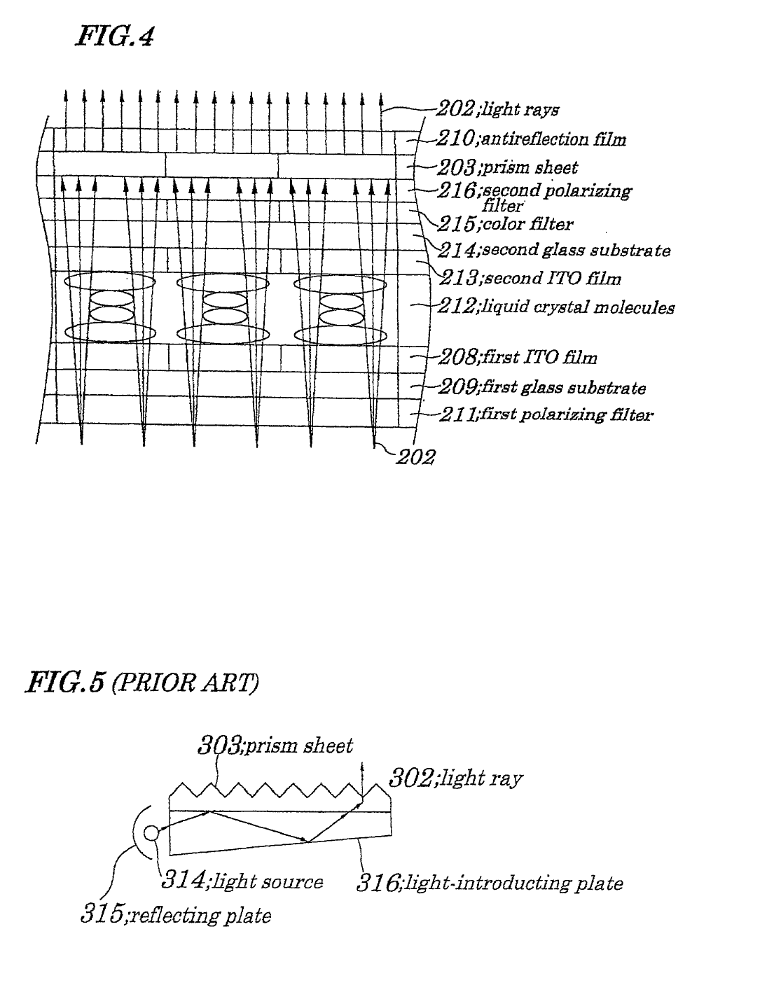

FIG. 4 is a schematic sectional view showing a liquid crystal image display apparatus provided with a prism sheet according to the second embodiment of the present invention. The present invention is applied to an organic EL display in the first embodiment, and the present invention can be also applied to a liquid crystal display. In FIG. 4, it is assumed that a light source of the liquid crystal display is a backlight (not shown). To change light rays 202 sent from the backlight into linearly polarized light, a first polarizing filter 211 is arranged under a first glass substrate 209. A first ITO film 208 that is a transparent electrode is formed on the first glass substrate 209, and elements (not shown) to be display elements of minimum display units forming an image are arranged in the first ITO film 208 in a matrix. The first glass substrate 209, the first polarizing filter 211 and the first ITO film 208 form a lower substrate part.

A second ITO film 213 that is a common electrode for controlling inclinations of liquid crystal molecules 212 is formed under a second glass substrate 214, and the liquid crystal molecules 212 are enclosed between the first ITO film 208 and the second ITO film 213. On the second glass substrate 214, a color filter 215 including a red element, a green element, and a blue element is provided so as to color the light rays 202 passing through the liquid crystal molecules 212. Each of the red element, the green element, and the blue element in the color filter 215 corresponds to each display element and is separated by a separator so as not to be interfered by one another. The second glass substrate 214, the color filter 215 and the second ITO film 213 form an upper substrate part. On the color filter 215, a second polarizing filter 216 for passing only linearly polarized light twisted at an angle of 90° by the liquid crystal molecules 212 is provided. On the second polarizing filter 216, a prism sheet 203 divided so as to correspond to each of the red element, the green element, and the blue element of the color filter 215 is formed. On the prism sheet 203, an antireflection film 210 for protecting reflection by outer light rays is laminated.

Next, explanations will be given of display operations of the liquid crystal image display apparatus having the prism sheet 203 according to the second embodiment of the present invention with reference to FIG. 4.

The light rays 202 from a backlight are linearly polarized by the first polarizing filter 211, pass through the first glass substrate 209, the first ITO film 208, the liquid crystal molecules 212, the second ITO film 213, and the second glass substrate 214, and then are respectively colored by the color filter 215 including the red element, the green element, and the blue element. The colored light rays 202 pass through the second polarizing filter 216, and then are condensed in a vertical upward direction of a display surface by the prism sheet 203. The second polarizing filter 216 generally passes only the light rays 202 twisted at the angle of 90° by the liquid crystal molecules 212 when an electrode of the first ITO film 208 corresponding to a display element forming an image is OFF.

In the second embodiment, the prism sheet 203 is laminated on the second polarizing filter 216 in an upper layer, however, the prism sheet 203 may be laminated in any number of layers only if the prism sheet 203 is put between the color filter 215 and the display surface, and a plurality of prism sheets 203 may be laminated.

It is thus apparent that the present invention is not limited to the above embodiments but may be changed and modified without departing from the scope and spirit of the invention.

What is claimed is:

1. An image display apparatus comprising:
one or more prism sheets provided between an image emitting surface of an image generating part in said image display apparatus and an image display surface of said image display apparatus, divided so as to be respectively corresponded to display elements that are minimum display units forming an image and provided with a prism surface on an exit surface so that light rays incident on an incident surface exit in an approximately vertical direction of said incident surface.

2. The image display apparatus according to claim 1, wherein said image display apparatus is an organic electroluminescence display and comprises a metal electrode layer, an electron carrying layer formed on an upper surface of said metal electrode layer, an emitting layer formed on an upper surface of said electron carrying layer, a hole carrying layer formed on an upper surface of said emitting layer, an Indium Tin Oxide film formed on an upper surface of said hole carrying layer, a glass substrate arranged on an upper surface of said Indium Tin Oxide film and an circularly polarizing filter and an antireflection film arranged on an upper surface of said glass substrate, and wherein said prism sheet is provided between said Indium Tin Oxide film and said antireflection film, is divided so as to be respectively corresponded to display elements that are minimum display units forming an image of said emitting layer and is provided with a prism surface on an exit surface so that light rays incident on an incident surface output in an approximately vertical direction of said incident surface.

3. The image display apparatus according to claim 2, wherein said prism sheet is provided between said glass substrate and said circularly polarizing filter.

4. The image display apparatus according to claim 1, wherein said image display apparatus is a liquid crystal display and comprises a lower substrate part including a first glass substrate, a first polarizing filter formed under a lower surface of said first glass substrate, and a first Indium Tin Oxide film formed on an upper surface of said glass substrate and provided with display elements that are minimum display units forming an image in a matrix, a light-introducing plate arranged under a lower surface of said lower substrate part, a light source arranged adjacently to said light-introducing plate, an upper substrate part including a second glass substrate, a color filter divided so as to be respectively corresponded to said display elements that are said minimum display units forming said image and formed on said second glass substrate and a second Indium Tin Oxide film that is a common electrode formed under a lower side of said second glass substrate, liquid crystal elements arranged between said lower substrate part and said upper substrate part, a second polarizing filter provided on an upper surface of said upper substrate part and antireflection film provided on said second polarizing filter, and wherein said prism sheet is provided between said upper substrate part and said antireflection film, is divided so as to be respectively corresponded to said display elements that are minimum display units forming an image and is provided with a prism surface on an exit surface so that light rays incident on an incident surface exit in an approximately vertical direction of said incident surface.

5. The image display apparatus according to claim 4, wherein said prism sheet is provided between said second polarizing filter and said antireflection film.

6. The image display apparatus according to claim 4, wherein said prism sheet is provided between said upper substrate sheet and said second polarizing filter.
